(19) United States
(12) Patent Application Publication
(10) Pub. No.: US 2017/0285820 A1
(43) Pub. Date: Oct. 5, 2017

(54) Touch Substrate And Touch Display Device

(71) Applicant: BOE TECHNOLOGY GROUP CO., LTD., Beijing (CN)

(72) Inventors: Wusheng LI, Beijing (CN); Shi SHU, Beijing (CN)

(73) Assignee: Boe Technology Group Co., Ltd., Beijing (CN)

(21) Appl. No.: 15/511,414

(22) PCT Filed: Feb. 22, 2016
(86) PCT No.: PCT/CN2016/074212

§ 371 Date: Mar. 15, 2017

(30) Foreign Application Priority Data
Mar. 13, 2015 (CN) 201510111903.1

(51) Int. Cl. G06F 3/041; G06F 3/044

(52) U.S. Cl. CPC G06F 3/0412; G06F 3/044; G06F 2203/04107; G06F 2203/04111; G06F 2203/04112

(57) ABSTRACT

The present disclosure provides a touch substrate and a touch display device. The touch substrate comprises a touch region and a frame region. A base substrate, a shielding layer and a wiring are sequentially layered in the frame region. The shielding layer comprises a non-black photoresist layer and a black photoresist layer. The touch substrate further comprises an anti-reflective layer disposed between the non-black photoresist layer and the black photoresist layer. The base substrate, the non-black photoresist layer, the anti-reflective layer, the black photoresist layer and the wiring are sequentially layered. The anti-reflective layer is configured to reduce the reflection of the black photoresist layer against incident light from the direction of the base substrate. By providing the anti-reflective layer, the present disclosure can achieve the technical effect of reducing the reflection of the black photoresist layer.

### CROSS REFERENCE TO RELATED APPLICATIONS

This application is a National Stage of PCT/CN2016/074212 filed Feb. 22, 2016, which claims the benefit and priority of Chinese Patent Application No. 201510111903.1, filed Mar. 13, 2015. The entire disclosures of the above applications are incorporated herein by reference.

### BACKGROUND

The present disclosure relates to the field of touch technology, and particularly to a touch substrate and a touch display device.

In One Glass Solution (OGS) technology, the conductive film and the touch sensor of Indium Tin Oxide (ITO) are directly formed on the protective glass of a display device. Using the OGS technology, one piece of glass can be used to protect the screen and form the touch sensor concurrently. The glass formed with the OGS technology can be cut to produce an OGS touch screen. The OGS technology can save one piece of glass substrate and save one cell process in production, compared with the traditional glass/glass (G/G) touch technology, so as to reduce production costs and improve yield rate. The touch screen obtained with the OGS technology has advantages of being light and thin, and having good transparency.

In the conventional OGS manufacturing process, Black Matrix (BM) layer is usually used to form a black frame to achieve the functions of wiring shielding and decoration. It is easy for the BM layer to have a sufficiently large Optical Density (OD, i.e., absorbance) to achieve a complete light-shielding effect. Recently, some manufacturers use non-black (e.g., white) frame. These non-black (e.g., white) frames generally use ink materials. As the process of ink materials is different from the photolithography process used in the conventional touch screen product line, the production inputs are increased. Otherwise, if the non-black (e.g., white) frame uses photoresist materials, its process can be the same as the current photolithography process in the production line, and the manufacture will be easier. However, since the OD value of the non-black (e.g., white) photoresist material is smaller than the OD value of the black photoresist material, it is still necessary to add a thin black photoresist layer in order to increase the OD value to achieve a complete light shielding effect. In such a structure, the reflectivity of the black photoresist layer is high, and the light reflected by the black photoresist layer is easily visible to the human eye, then possibly makes the frame color become cyan. In this case, the non-black (e.g., white) photoresist layer must be sufficiently thick to reduce the light reflected by the black photoresist layer to the human eye such that the non-black (e.g., white) frame does not appear to be cyan. This thickness of the non-black (e.g., white) photoresist layer tends to break the ITO wiring, and result in a lower yield.

FIG. 1 is a sectional view of a touch substrate in the prior art, in which the touch substrate includes a base substrate 1, a non-black photoresist layer 2, a black photoresist layer 3, and an ITO wiring 4 layered sequentially. The cross-section illustrated in this sectional view crosses the touch region and the frame region, is parallel to the extending direction of the ITO wiring 4, and passes one piece of the ITO wiring 4. In FIG. 1, since the thickness of the non-black photoresist layer 2 is too large, the ITO wiring 4 is broke.

### BRIEF DESCRIPTION

Embodiments of the present disclosure provide a touch substrate and a touch display device.

According to a first aspect, embodiments of the present disclosure provide a touch substrate including a touch region and a frame region, wherein a base substrate, a shielding layer and a wiring are sequentially layered in the frame region. The shielding layer includes a non-black photoresist layer and a black photoresist layer. Wherein, the touch substrate further includes an anti-reflective layer disposed between the non-black photoresist layer and the black photoresist layer. The base substrate, the non-black photoresist layer, the anti-reflective layer, the black photoresist layer and the wiring are sequentially layered. The anti-reflective layer is configured to reduce the reflection of the black photoresist layer against incident light from the direction of the base substrate.

In embodiments of the present disclosure, the anti-reflective layer is configured such that, for the incident light, an optical path difference between the two reflected lights respectively reflected at the upper surface and lower surface of the anti-reflective layer is an odd multiple of a half wavelength of the incident light.

In embodiments of the present disclosure, the anti-reflective layer is configured such that ΔS=2nd=(2m−1)λ/2, wherein n is the refractive index of the anti-reflective layer for the incident light, d is the thickness of the anti-reflective layer, m is a positive integer, ΔS is the optical path difference, and λ is a wavelength of the incident light.

In embodiments of the present disclosure, the anti-reflective layer has a thickness between 0.1 microns and 0.2 microns.

In embodiments of the present disclosure, the material of the anti-reflective layer includes silicon nitride, silicon oxide, or silicon oxynitride.

In embodiments of the present disclosure, the material of the non-black photoresist layer includes a resin.

In embodiments of the present disclosure, the thickness of the non-black photoresist layer is between 8 microns and 12 microns.

In embodiments of the present disclosure, the touch substrate further includes a protective layer covering the wiring and the black photoresist layer.

In embodiments of the present disclosure, the material of the protective layer includes one or more of acrylic resin, silicon nitride, silicon oxide, and silicon oxynitride.

According to a second aspect, embodiments of the present disclosure provide a touch display device including the touch substrate according to any one of the above and a display substrate.

In the touch substrate and the touch display device provided by the embodiments of the present disclosure, it is possible to achieve the technical effect of reducing the reflection of the black photoresist layer by providing the anti-reflective layer. Accordingly, the thickness of the non-black photoresist layer can be reduced correspondingly, so as to solve the technical problem that the ITO wiring or the metal wiring easily breaks due to the excessively thick non-black photoresist layer.

### BRIEF DESCRIPTION OF THE DRAWINGS

In order to more clearly illustrate the technical solution in the embodiments of the present disclosure, the drawings to be used in the description of the embodiments of the present disclosure will be simply described below. Obviously, the drawings in the following description are merely for some embodiments of the present disclosure, from which those skilled in the art may also obtain other drawings without creative work.

FIG. 1 is a sectional view of a touch substrate in the prior art;

FIG. 2 is a sectional view of a touch substrate according to a first embodiment of the present disclosure;

FIG. 3 is a reflection optical path diagram of incident light reflected by an anti-reflective layer in the touch substrate shown in FIG. 2;

FIG. 4 is another sectional view of the touch substrate shown in FIG. 2.

### DETAILED DESCRIPTION

In order to more clearly describe the, technical solutions and advantages of the embodiments of the present disclosure, the technical solutions in the embodiments of the present disclosure will be clearly and completely described below in conjunction with the accompanying drawings in the embodiments of the present disclosure. Obviously, the described embodiments are a part of the embodiments of the present disclosure, rather than all the embodiments. Based on the embodiments of the present disclosure, all other embodiments obtained by those skilled in the art without creative work fall within the protection scope of the present disclosure.

FIG. 2 is a sectional view of a touch substrate according to a first embodiment of the present disclosure. As shown in FIG. 2, the touch substrate of this embodiment includes a touch region 7 and a frame region 6. The frame region 6 is provided with a base substrate 1, a shielding layer 8 and a wiring 4, which are sequentially layered. The shielding layer 8 includes a non-black photoresist layer 2 and a black photoresist layer 3. The touch substrate further includes an anti-reflective layer 5 disposed between the non-black photoresist layer 2 and the black photoresist layer 3. The base substrate 1, the non-black photoresist layer 2, the anti-reflective layer 5, the black photoresist layer 3 and the wiring 4 are sequentially layered. The anti-reflective layer 5 is configured to reduce the reflection of the black photoresist layer 3 against incident light from the direction of the base substrate 1. The base substrate 1 may be selected from glass, transparent lenses, or transparent passivating materials which are preferred for finger touching and light transmission. Hereinafter, the description will be given by example of the wiring 4 as an ITO wiring, but it should be understood that the wiring 4 may also be other types of metal wirings.

The cross-section in FIG. 2 crosses the touch region 7 and the frame region 6, and is perpendicular to the extending direction of the ITO wiring 4. In FIG. 2, the touch substrate can be divided into a touch region 7 and a frame region 6 according to the function, and the frame region 6 surrounds the touch region 7. The shielding layer 8 is provided in the frame region 6 for shielding the wiring 4 and the light probably transmitted from the frame region 6 (mainly the backlight of the display panel using the touch substrate). The shielding layer 8 includes a non-black photoresist layer 2 and a thin black photoresist layer 3 which is added in order to reach a necessary OD value, and further includes a thin anti-reflective layer 5 added and disposed therebetween for reducing the reflectance of the black photoresist layer 3. The anti-reflective layer 5 can reduce the thickness of the non-black photoresist layer 2 and then reduce the breakage of the ITO wiring 4. Herein, what the anti-reflective layer 5 reduces is the reflection of the black photoresist layer 3 against the external light. The external light is natural light incident from the outside of the touch substrate (i.e., external of the display panel), which is different from the backlight in the display panel.

FIG. 3 is a reflection optical path diagram of the incident light reflected by the anti-reflective layer in the touch substrate shown in FIG. 2. In order to better explain the incidence and reflection path of light, the up and down directions in FIG. 3 and FIG. 2 are reversed. As shown in FIG. 3, in practice, external light is first incident to the non-black photoresist layer 2, next to the anti-reflective layer 5, and then to the thin black photoresist layer 3. That is, the external light first passes through the non-black photoresist layer 2 and the anti-reflective layer 5, and then reaches the black photoresist layer 3. The anti-reflective layer 5 serves to reduce the reflection of the thin black photoresist layer 3, so as to thin the non-black photoresist layer 2.

In embodiments of the present disclosure, the anti-reflective layer 5 may be configured such that, for the incident light (i.e., the incident external light), the optical path difference between the two reflected lights respectively reflected at the upper surface and lower surface of the anti-reflective layer 5 is an odd multiple of a half wavelength of the incident light.

In embodiments of the present disclosure, the anti-reflective layer 5 is configured such that ΔS=2nd=(2m−1)λ/2, wherein n is the refractive index of the anti-reflective layer 5 for the incident light, d is the thickness of the anti-reflective layer 5, m is a positive integer, ΔS is the optical path difference, and λ is a wavelength of the incident light. When the incident light passes the non-black photoresist layer 2 and the anti-reflective layer 5, then to the thin black photoresist layer 3, reflection is generated at the upper surface and the lower surface of the anti-reflective layer 5 respectively. Since light is an electromagnetic wave, if the optical path difference between the two reflected lights satisfies an odd multiple of the half wavelength of the incident light, the two reflected lights will interfere destructively such that the intensity of the reflected light is further reduced or there is no reflected light, in this case, the optical path difference AS and the wavelength of the incident light λ satisfy the above equation. Thus, the light incident to the black photoresist layer 3 and the light reflected by the black photoresist layer 3 will be further reduced or absent. For example, when the wavelength λ of the incident light is 550 nm and the refractive index n of the anti-reflective layer 5 for the incident light n=1.0, the thickness d of the anti-reflective layer can be obtained as 550 nm/4=137.5 nm=0.1375 μm, wherein m=1.

In embodiments of the present disclosure, considering the structure limitations of the touch substrate, the anti-reflective layer 5 has a thickness between 0.1 microns and 0.2 microns. When the anti-reflective layer 5 of about 0.1 μm is added, about 10 μm of the thickness of the non-black photoresist layer 2 can be reduced to solve the problem of the ITO wiring or other types of metal wirings being easily broke.

In embodiments of the present disclosure, the material of the anti-reflective layer 5 may include silicon nitride, silicon oxide, or silicon oxynitride. The selection of its material mainly depends on its refractive index and transparency. The refractive index of the material is related to its thickness, and the transparency should be considered in conjunction with the color of the non-black photoresist layer 2.

In embodiments of the present disclosure, the material of the non-black photoresist layer 2 may include a resin with a thickness of about 20 μm. More specifically, the thickness of the non-black photoresist layer 2 may be between 8 μm and 12 μm.

In embodiments of the present disclosure, the touch substrate may further include a protective layer 9 covering the wiring and the black photoresist layer 3.

In embodiments of the present disclosure, the material of the protective layer 9 may include one or more of acrylic resin, silicon nitride, silicon oxide, and silicon oxynitride.

As shown in FIG. 2, in this embodiment, the ITO wiring 4 may be provided in the touch region 7, and a plurality of island-like capacitive touch sensing electrodes or a rhombic ITO layer may be formed in the touch region 7. The capacitive touch sensing electrodes in one direction (in the same row) are directly connected, and the electrodes in another direction (in the same column) are connected using a conductive bridge structure. Touch signals obtained by the capacitive touch sensing electrodes in the two directions may be transmitted through the wiring structure of the ITO wiring 4 to a flexible circuit board (not shown) and then to an integrated circuit (not shown), so as to realize the processing of the touch signals.

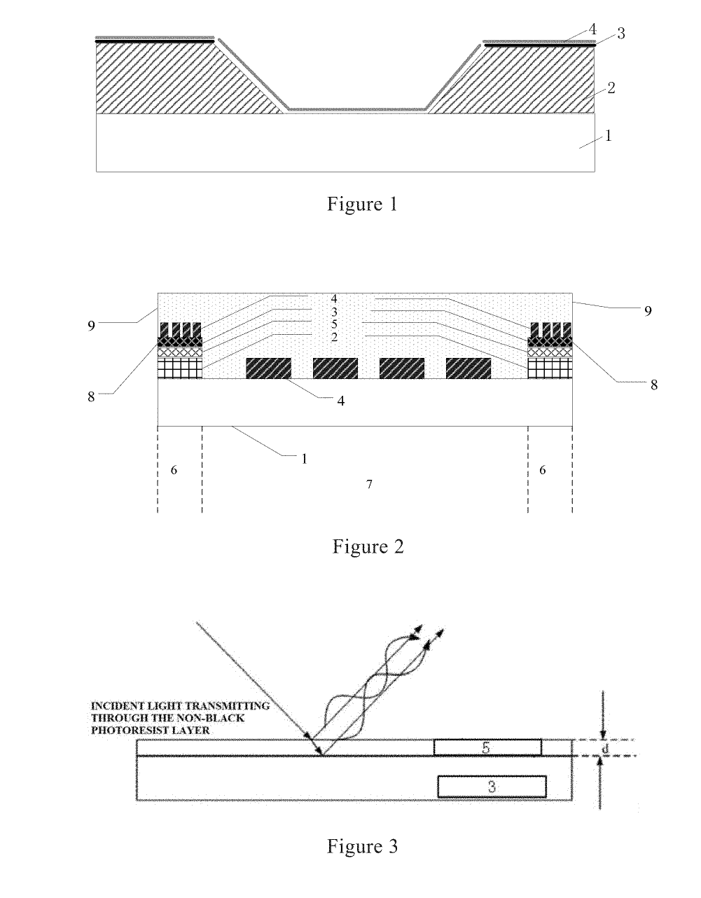

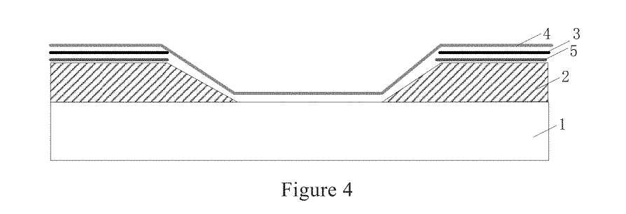

FIG. 4 is another sectional view of the touch substrate shown in FIG. 2. The position of the cross-section in FIG. 4 is the same as that in FIG. 1. The thickness of the non-black photoresist layer 2 in this example can be reduced by about 10 μm compared with the prior art. According to the touch substrate provided by the embodiments of the present disclosure, the thickness of the non-black photoresist layer 2 can be significantly reduced.

According to a second embodiment of the present disclosure, there is provided a touch display device including the touch substrate of the first embodiment and a display substrate. In the present embodiment, the touch substrate and the display substrate may be integrated by cell process.

In the touch substrate and the touch display device provided by the embodiments of the present disclosure, it is possible to achieve the technical effect of reducing the reflection of the black photoresist layer by providing the anti-reflective layer. Accordingly, the thickness of the non-black photoresist layer can be reduced correspondingly, so as to solve the technical problem of the ITO wiring or the metal wiring being easily broke due to the excessively thick non-black photoresist layer.

At last, it is to be understood that the above embodiments are merely used to illustrate the technical solutions of the present disclosure, but not intended to be limiting thereof. Although the present disclosure has been described in detail with reference to the foregoing embodiments, those skilled in the art should understand that the technical solutions described in the foregoing embodiments may be modified or equivalently substituted for some of the technical features. These modifications and substitutions do not make the essence of the corresponding technical solutions depart from the spirit and scope of the technical solutions of the embodiments of the disclosure.

1. A touch substrate comprising:
a touch region; and
a frame region;
wherein a base substrate, a shielding layer and a wiring are sequentially layered in the frame region, wherein the shielding layer comprises a non-black photoresist layer and a black photoresist layer,
wherein the touch substrate further comprises an anti-reflective layer disposed between the non-black photoresist layer and the black photoresist layer, wherein the base substrate, the non-black photoresist layer, the anti-reflective layer, the black photoresist layer and the wiring are sequentially layered, and
wherein the anti-reflective layer is configured to reduce the reflection of the black photoresist layer against incident light from the direction of the base substrate.

2. The touch substrate according to claim 1, wherein the anti-reflective layer is configured such that, for the incident light, an optical path difference between two reflected lights respectively reflected at the upper surface and lower surface of the anti-reflective layer is an odd multiple of a half wavelength of the incident light.

3. The touch substrate according to claim 2, wherein the anti-reflective layer is configured such that ΔS=2nd=(2m−1)λ/2, wherein n is the refractive index of the anti-reflective layer for the incident light, d is the thickness of the anti-reflective layer, m is a positive integer, ΔS is the optical path difference, and λ is a wavelength of the incident light.

4. The touch substrate according to claim 1, wherein the thickness of the anti-reflective layer is between 0.1 microns and 0.2 microns.

5. The touch substrate according to claim 1, wherein the material of the anti-reflective layer comprises silicon nitride, silicon oxide, or silicon oxynitride.

6. The touch substrate according to claim 1, wherein the material of the non-black photoresist layer comprises a resin.

7. The touch substrate according to claim 1, wherein the thickness of the non-black photoresist layer is between 8 microns and 12 microns.

8. The touch substrate according to claim 1, wherein the touch substrate further comprises a protective layer covering the wiring and the black photoresist layer.

9. The touch substrate according to claim 8, wherein the material of the protective layer comprises one or more of acrylic resin, silicon nitride, silicon oxide, and silicon oxynitride.

10. A touch display device comprising the touch substrate according to claim 1 and a display substrate.

11. The touch substrate according to claim 2, wherein the thickness of the anti-reflective layer is between 0.1 microns and 0.2 microns.

12. The touch substrate according to claim 3, wherein the thickness of the anti-reflective layer is between 0.1 microns and 0.2 microns.

13. The touch substrate according to claim 2, wherein the touch substrate further comprises a protective layer covering the wiring and the black photoresist layer.

14. The touch substrate according to claim 3, wherein the touch substrate further comprises a protective layer covering the wiring and the black photoresist layer.

15. The touch substrate according to claim 4, wherein the touch substrate further comprises a protective layer covering the wiring and the black photoresist layer.

16. The touch substrate according to claim 5, wherein the touch substrate further comprises a protective layer covering the wiring and the black photoresist layer.

17. The touch substrate according to claim 6, wherein the touch substrate further comprises a protective layer covering the wiring and the black photoresist layer.

18. The touch substrate according to claim 7, wherein the touch substrate further comprises a protective layer covering the wiring and the black photoresist layer.

19. The touch display device according to claim 10, wherein the anti-reflective layer is configured such that, for the incident light, an optical path difference between two reflected lights respectively reflected at the upper surface and lower surface of the anti-reflective layer is an odd multiple of a half wavelength of the incident light.

20. The touch display device according to claim 10, wherein the anti-reflective layer is configured such that ΔS=2nd=(2m−1)λ/2, wherein n is the refractive index of the anti-reflective layer for the incident light, d is the thickness of the anti-reflective layer, m is a positive integer, ΔS is the optical path difference, and λ is a wavelength of the incident light.
